(19) United States
(12) Patent Application Publication
(10) Pub. No.: US 2011/0115924 A1
(43) Pub. Date: May 19, 2011

(54) IMAGE PICKUP DEVICE

(75) Inventors: Chien-Nan Yu, Taipei (TW); Szu-Hao Lyu, Taipei (TW)

(73) Assignee: PRIMAX ELECTRONICS LTD., Taipei (TW)

(21) Appl. No.: 12/703,017

(22) Filed: Feb. 9, 2010

(30) Foreign Application Priority Data
Nov. 13, 2009 (TW) 098138659

(51) Int. Cl. H04N 5/225

(52) U.S. Cl. 348/207.11; 348/E05.024

(57) ABSTRACT

An image pickup device is connected with a computer. A video program is installed in the computer. The image pickup device includes an image pickup module and a monitor program. The image pickup module is controlled by the video program to capture an image. The image pickup module includes a lens and a shielding cover in front of the lens. When the monitor program detects an execution status of the video program, the shielding cover is driven to move to a position where the lens is not shielded by the shielding cover. When the monitor program detects a non-execution status of the video program, the shielding cover is driven to move to a position where the lens is shielded by the shielding cover.

### FIELD OF THE INVENTION

The present invention relates to an image pickup device, and more particularly to an image pickup device with a lens cover.

### BACKGROUND OF THE INVENTION

With increasing development of high technology industries, computers and their peripheral devices become essential electronic apparatuses in our daily lives. Image pickup devices are widely used in notebook computers to take photographs or record video data in order to provide convenience to the human beings. For example, through the video conference, the users at different cities or countries could discuss with each other. When a network communication program is executed to perform a videoconferencing function, the image of a first user could be captured by a web camera of a computer system at a first terminal. By the network communication program, the image of the first user at the first terminal is transmitted to the computer system of a second user at a second terminal through internet connection. As such, the image of the first user could be outputted from the computer monitor or an image output device at the second terminal. Similarly, by the same manner, the image of the second user could be obtained by the web camera of the computer system at the second terminal and then transmitted to the first user at the first terminal. Under this circumstance, the videoconferencing technique will enable individual users in faraway sites to have meetings or communicate with each other.

As the network communication becomes more popular, numerous malicious network events such as computer virus and hacker attack make the network management more difficult. Through network connection, the user's computer is possibly infected with malicious programs such a Trojan horse program. Once a Trojan horse has been installed on a target computer, it is possible for a hacker to access the computer remotely and perform various criminal actions. For example, if the web camera of the computer system is remotely enabled by the network hacker, the environmental image at the user terminal is revealed to the unknown instances or even illegally recorded. In this circumstance, the secrets of the user are intruded.

For solving the above drawbacks, the conventional web camera has a movable cover for shielding the lens when the web camera is not in use. FIGS. 1A and 1B are schematic perspective views illustrating a web camera according to the prior art. As shown in FIGS. 1A and 1B, the web camera 1 comprises a lens 10 and a movable cover 11. For using the web camera 1, the movable cover 11 needs to be manually moved in the direction D1. As such, the lens 10 could capture the environmental image at the user terminal (see FIG. 1A). Whereas, in a case that the user does not intend to use the web camera 1, the movable cover 11 is manually moved in the direction D2 in order to shelter the lens 10 (see FIG. 1B). Even if the web camera 1 is remotely controlled by the network hacker, the network hacker fails to snoop around the environment of the web camera 10 because the lens is sheltered by the movable cover 11.

The web camera 1, however, still has some drawbacks. For example, whenever the web camera 1 is switched from a usage status to a non-usage status or from the non-usage status to the usage status, the user should make a special effort to manually move the movable cover 11. That is, the use of the web camera 1 is inconvenient. If the user forgets to push back the movable cover 11 to shelter the lens 10 after the web camera 1 has been used, the possibility of incurring hacker intrusion is largely increased.

### SUMMARY OF THE INVENTION

The present invention provides an image pickup device with a shielding cover, in which the shielding cover is selectively in an open position or a close position by means of a computer program and magnetic induction.

In accordance with an aspect of the present invention, there is provided an image pickup device. The image pickup device is connected with a computer. A video program is installed in the computer. The image pickup device includes an image pickup module and a monitor program. The image pickup module is controlled by the video program to capture an image. The image pickup module includes a lens, a shielding cover in front of the lens, and a driving element for driving the shielding cover to be in either an open position or a close position. When the shielding cover is in the open position, the lens is not shielded by the shielding cover. Whereas, when the shielding cover is in the close position, the lens is shielded by the shielding cover. The monitor program is installed in the computer for detecting an operating status of the video program. When the monitor program detects an execution status of the video program, the monitor program issues a first signal to the computer, and the shielding cover is driven by the driving element to move to the open position in response to the first signal. Whereas, when the monitor program detects a non-execution status of the video program, the monitor program issues a second signal to the computer, and the shielding cover is driven by the driving element to move to the close position in response to the second signal.

In an embodiment, the driving element is an electromagnet and shielding cover is a magnetic body. When the first signal issued from the monitor program is received by the computer, the computer provides a first-direction electric current to the driving element, so that a magnetically repulsive force is generated between the driving element and the shielding cover to move the shielding cover to the open position.

In an embodiment, the driving element is an electromagnet and shielding cover is a magnetic body. When the second signal issued from the monitor program is received by the computer, the computer provides a second-direction electric current to the driving element, so that a magnetically attractive force is generated between the driving element and the shielding cover to move the shielding cover to the close position. The second-direction electric current is reverse to the first-direction electric current.

In an embodiment, the driving element is disposed under the shielding cover. When the second signal issued from the monitor program is received by the computer, the computer stops providing the first-direction electric current to the driving element, so that the shielding cover is moved to the close position.

In an embodiment, the computer is a notebook computer.

In an embodiment, the image pickup module is embedded in an upper edge of a screen of the notebook computer.

In an embodiment, the image pickup device is disposed in a web camera, and the web camera is connected to a computer through a universal serial bus.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A and 1B are schematic perspective views illustrating a web camera according to the prior art;

FIGS. 2A and 2B are schematic perspective views illustrating the application of an image capture device according to a first embodiment of the present invention;

FIGS. 3A and 3B are schematic perspective views illustrating the application of an image pickup device according to a second embodiment of the present invention;

FIGS. 4A and 4B are schematic perspective views illustrating the application of an image pickup device according to a third embodiment of the present invention; and

FIGS. 5A and 5B are schematic perspective views illustrating the application of an image pickup device according to a fourth embodiment of the present invention.

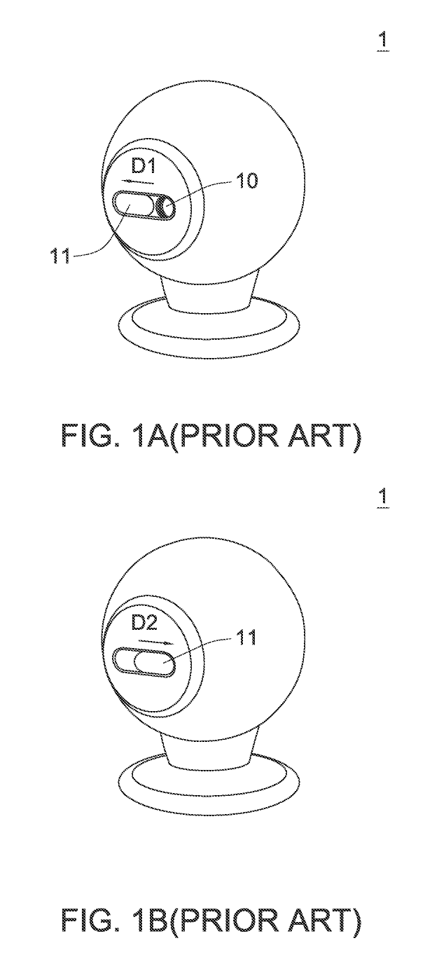

### DETAILED DESCRIPTION OF THE PREFERRED EMBODIMENT

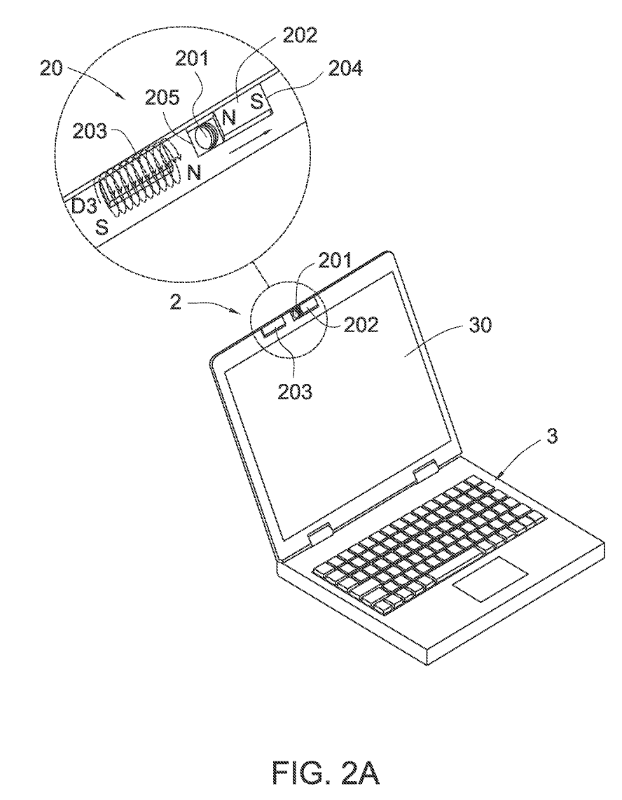

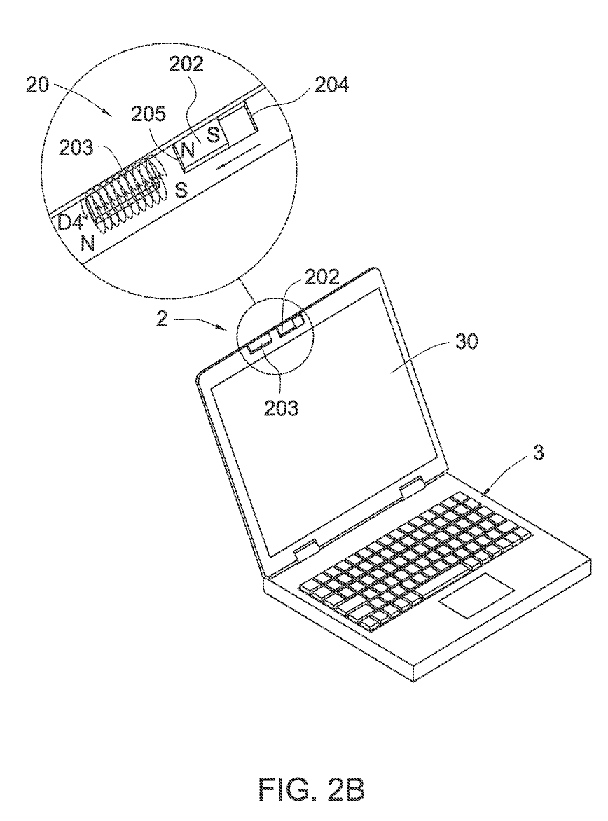

FIGS. 2A and 2B are schematic perspective views illustrating the application of an image pickup device according to a first embodiment of the present invention. As shown in FIGS. 2A and 2B, the image pickup device 2 comprises an image pickup module 20 and a monitor program. The monitor program is installed in a notebook computer 3. The image pickup module 20 is embedded in an upper edge of a screen 30 of the notebook computer 3 for capturing the environmental image at the user terminal. The image pickup module 20 comprises a lens 201, a shielding cover 202 and a driving element 203. The lens 201 is used for capturing images. The shielding cover 202 is disposed in front of the lens 201. The driving element 203 is used for driving the shielding cover 202 to move in an open position or a close position.

In accordance with a key feature of the present invention, the shielding cover 202 could be driven to move in the leftward or rightward direction. In a case that the shielding cover 202 is moved in the rightward direction to the open position 204, the lens 201 is not shielded by the shielding cover 202. As such, the lens 201 could be used for capturing images. Whereas, in a case that the shielding cover 202 is moved in the leftward direction to the close position 205, the lens 201 is shielded by the shielding cover 202. In this circumstance, the image pickup module 20 fails to perform the image-capturing action. In this embodiment, the shielding cover 202 is a magnetic body (e.g. a magnet). The left side and the right side of the magnetic body are respectively a magnetic N pole and a magnetic S pole. An example of the driving element 203 is an electromagnet (e.g. an iron bar). The driving element 203 is parallel with and fixed at a position near the left side of the shielding cover 202. When an electric current passes through the driving element 203, a magnetic field is generated. As such, a magnetically attractive force or a magnetically repulsive force is generated between the driving element 203 and the shielding cover 202, thereby driving the magnetic shielding cover 202 to move in the leftward or rightward direction.

Furthermore, a video program is also installed in the notebook computer 3. By executing the video program, the operations of the image pickup module 20 will be controlled. By executing the monitor program, the operating status of the video program will be detected.

Please refer to FIG. 2A. When the video program is executed, the image pickup module 20 is enabled to perform an image-capturing operation. At the same time, the monitor program detects execution of the video program, thereby issuing a first signal to the notebook computer 3. In response to the first signal, the notebook computer 3 provides an electric current to the driving element 203, wherein the electric current flows in a first direction D3. Since the driving element 203 is an electromagnet, a magnetic field is generated. In response to the electric current flowing in the first direction D3, the left side and the right side of the driving element 203 are respectively a magnetic S pole and a magnetic N pole. Since the right side of the driving element 203 and the left side of the shielding cover 202 have like poles (N poles), a magnetically repulsive force is generated between the driving element 203 and the shielding cover 202. Due to the magnetically repulsive force, the shielding cover 202 is driven to move from the close position 205 to the open position 204 in the rightward direction.

Please refer to FIG. 2B. When the video program is closed, the image pickup module 20 fails to perform an image-capturing operation. At the same time, the monitor program detects non-execution of the video program, thereby issuing a second signal to the notebook computer 3. In response to the second signal, the notebook computer 3 provides an electric current to the driving element 203, wherein the electric current flows in a second direction D4. The second direction D4 is reverse to the first direction D3. In response to the electric current flowing in the second direction D4, the left side and the right side of the driving element 203 are respectively a magnetic N pole and a magnetic S pole. Since the right side of the driving element 203 and the left side of the shielding cover 202 have opposite poles, a magnetically attractive force is generated between the driving element 203 and the shielding cover 202. Due to the magnetically attractive force, the shielding cover 202 is driven to move from the open position 204 to the close position 205 in the leftward direction.

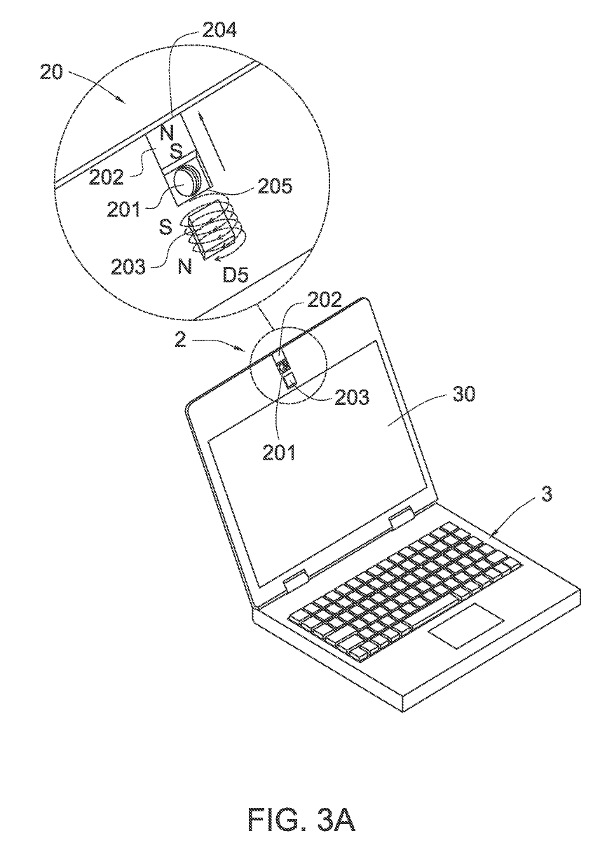

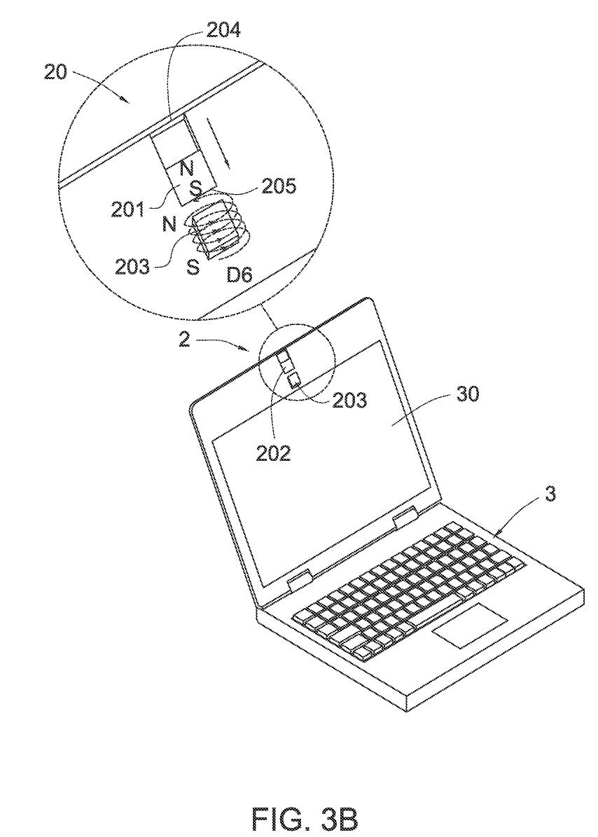

FIGS. 3A and 3B are schematic perspective views illustrating the application of an image pickup device according to a second embodiment of the present invention. In contrast with the first embodiment, the driving element 203 is fixed at a position near the bottom side of the shielding cover 202. The top side and the bottom side of the shielding cover 202 are respectively a magnetic N pole and a magnetic S pole. The shielding cover 202 is driven to move in the upward or downward direction rather than the leftward or rightward direction. In a case that the shielding cover 202 is moved in the upward direction to the open position 204, the lens 201 is not shielded by the shielding cover 202. As such, the lens 201 could be used for capturing images. Whereas, in a case that the shielding cover 202 is moved in the downward direction to the close position 205, the lens 201 is shielded by the shielding cover 202. In this circumstance, the image pickup module 20 fails to perform the image-capturing action.

Please refer to FIG. 3A. When the monitor program detects execution of the video program, a first signal is issued to the notebook computer 3. In response to the first signal, the notebook computer 3 provides an electric current to the driving element 203, wherein the electric current flows in a third direction D5. In response to the electric current flowing in the third direction D5, the top side and the bottom side of the driving element 203 are respectively a magnetic S pole and a magnetic N pole. Since the top side of the driving element 203 and the bottom side of the shielding cover 202 have like poles (S poles), a magnetically repulsive force is generated between the driving element 203 and the shielding cover 202. Due to the magnetically repulsive force, the shielding cover 202 is driven to move from the close position 205 to the open position 204 in the upward direction.

Please refer to FIG. 3B. When the monitor program detects non-execution of the video program, a second signal is issued to the notebook computer 3. In response to the second signal, the notebook computer 3 provides an electric current to the driving element 203, wherein the electric current flows in a fourth direction D6. The fourth direction D6 is reverse to the third direction D5. In response to the electric current flowing in the fourth direction D6, the top side and the bottom side of the driving element 203 are respectively a magnetic N pole and a magnetic S pole. Since the top side of the driving element 203 and the bottom side of the shielding cover 202 have opposite poles, a magnetically attractive force is generated between the driving element 203 and the shielding cover 202. Due to the magnetically attractive force, the shielding cover 202 is driven to move from the open position 204 to the close position 205 in the downward direction.

It is noted that, however, those skilled in the art will readily observe that numerous modifications and alterations may be made while retaining the teachings of the invention. For example, when the first signal is received by the notebook computer 3, the notebook computer 3 provides an electric current to the driving element 203, wherein the electric current flows in a third direction D5. Whereas, when the second signal is received by the notebook computer 3, the notebook computer 3 stops providing the electric current. Since no magnetic field is generated by the driving element 203, the magnetically repulsive force is generated between the driving element 203 and the shielding cover 202 disappears. Due to gravity, the shielding cover 202 naturally moves from the open position 204 to the close position 205 in the downward direction. In this circumstance, no additional power consumption is required to move the shielding cover 202 to the close position.

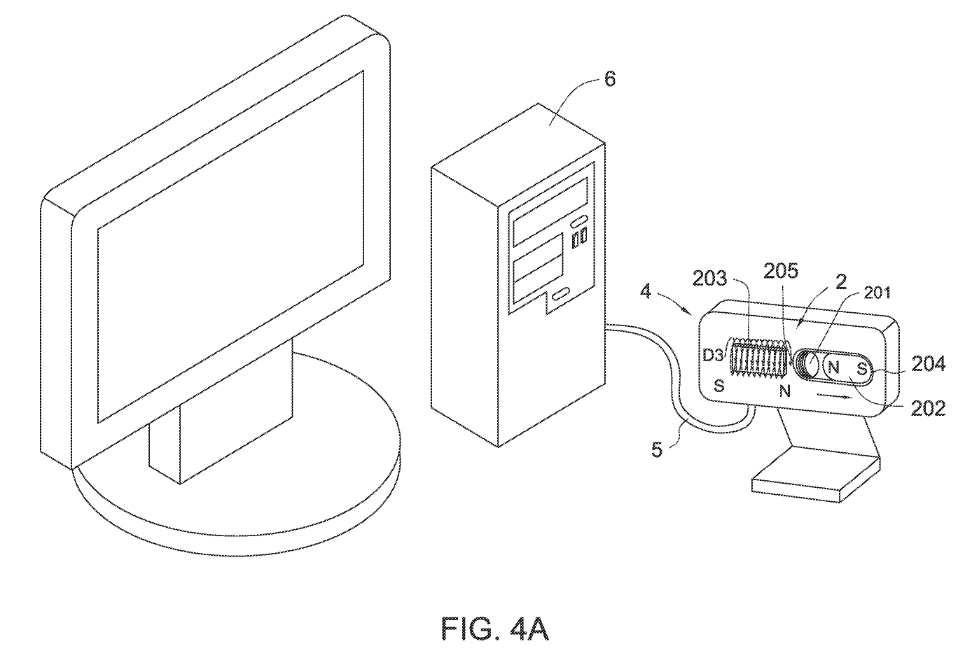

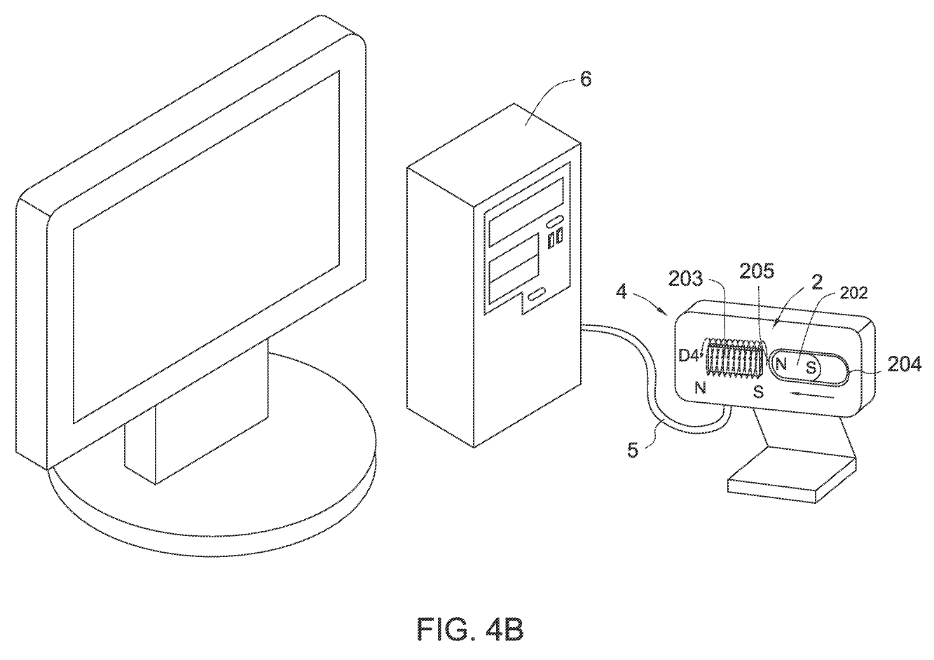

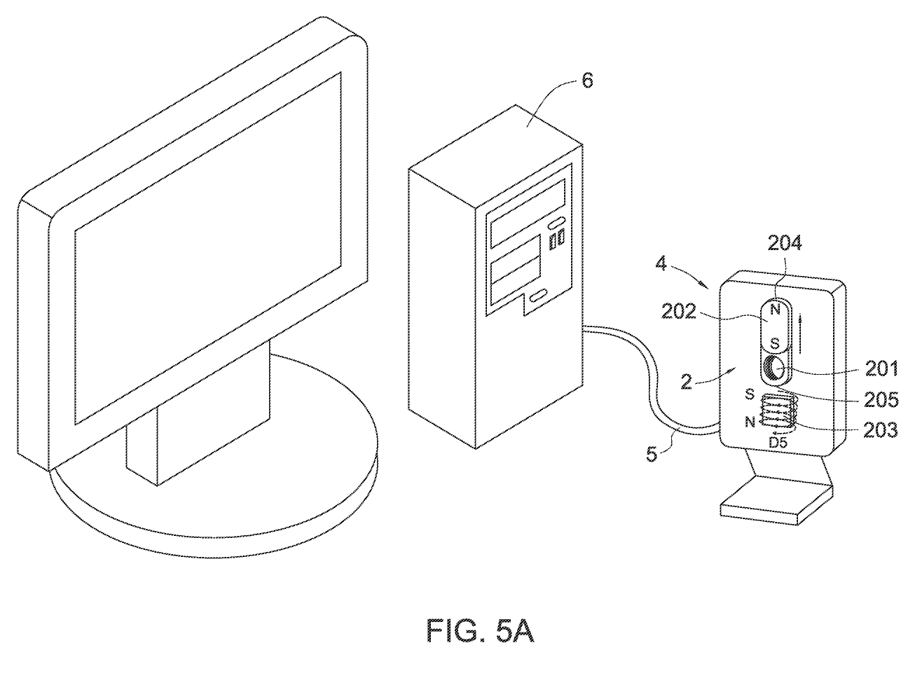

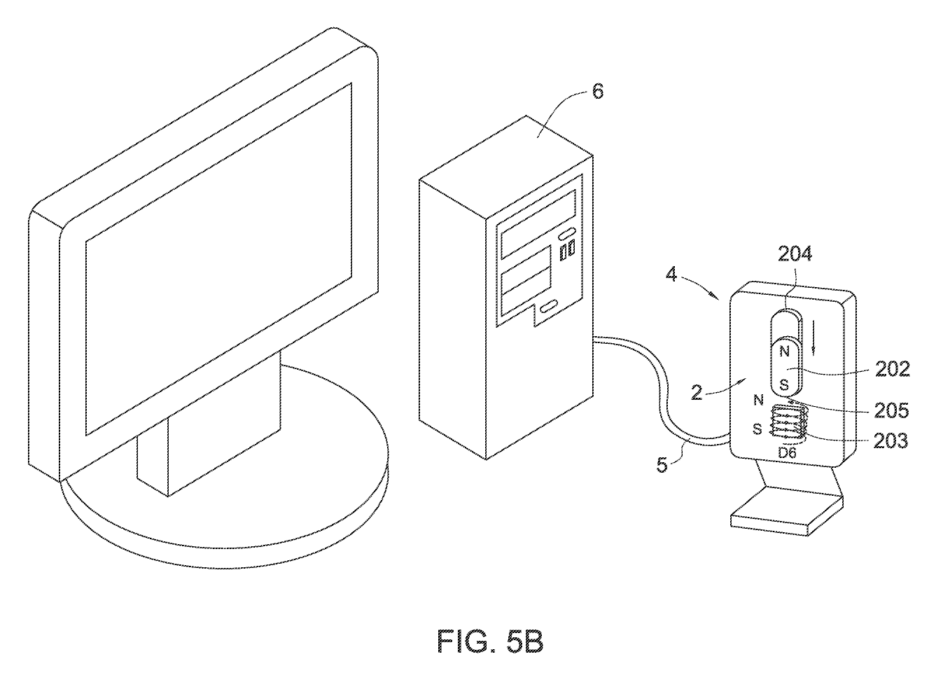

In the above embodiments, the image pickup device 2 is applied to the notebook computer 3. Nevertheless, the image pickup device 2 may be applied to any other video device in the art. FIGS. 4A and 4B are schematic perspective views illustrating the application of an image pickup device according to a third embodiment of the present invention. FIGS. 5A and 5B are schematic perspective views illustrating the application of an image pickup device according to a fourth embodiment of the present invention. In contrast to the first and second embodiments, the image pickup device 2 of the third and fourth embodiments is disposed in a web camera 4, and the web camera 4 is connected to a computer 6 through a universal serial bus (USB) 5. Similarly, a video program is installed in the computer 6 for controlling the image pickup module 20. Similarly, a monitor program is installed in the computer 6 for detecting the operating status of the video program. The operating principles of the video program and the monitor program are similar to those illustrated in the first and second embodiments, and are not redundantly described herein.

From the above description, the shielding cover 202 disposed in front of the lens 201 of the image pickup device 2 could be automatically and magnetically driven to move to either the open position 204 or the close position 205 at the time when the video program is executed or not executed. Since the shielding cover 202 does not needs to be manually moved when the image pickup device 2 is switched between the usage status and non-usage status, the image pickup device 2 becomes more user-friendly. In case that the image pickup device 2 is in a non-usage state (that is, the video program is not executed) but the shielding cover 202 is automatically located in the open position 204, it is meant that the computer is possibly intruded by a network hacker and the video program is remotely controlled to be executed. At this time, the user should enhance alertness and immediately take a measure to prevent the network hacker from accessing the computer.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image pickup device connected with a computer, a video program being installed in said computer, said image pickup device comprising:
an image pickup module controlled by said video program to capture an image, said image pickup module comprising a lens, a shielding cover in front of said lens, and a driving element for driving said shielding cover to be in either an open position or a close position, wherein said lens is not shielded by said shielding cover when said shielding cover is in said open position, and said lens is shielded by said shielding cover when said shielding cover is in said close position; and
a monitor program installed in said computer for detecting an operating status of said video program,
wherein when said monitor program detects an execution status of said video program, said monitor program issues a first signal to said computer, and said shielding cover is driven by said driving element to move to said open position in response to said first signal,
wherein when said monitor program detects a non-execution status of said video program, said monitor program issues a second signal to said computer, and said shielding cover is driven by said driving element to move to said close position in response to said second signal.

2. The image pickup device according to claim 1 wherein said driving element is an electromagnet and shielding cover is a magnetic body, wherein when said first signal issued from said monitor program is received by said computer, said computer provides a first-direction electric current to said driving element, so that a magnetically repulsive force is generated between said driving element and said shielding cover to move said shielding cover to said open position.

3. The image pickup device according to claim 2 wherein said driving element is an electromagnet and shielding cover is a magnetic body, wherein when said second signal issued from said monitor program is received by said computer, said computer provides a second-direction electric current to said driving element, so that a magnetically attractive force is generated between said driving element and said shielding cover to move said shielding cover to said close position, wherein said second-direction electric current is reverse to said first-direction electric current.

4. The image pickup device according to claim 2 wherein said driving element is disposed under said shielding cover, wherein when said second signal issued from said monitor program is received by said computer, said computer stops providing said first-direction electric current to said driving element, so that said shielding cover is moved to said close position.

5. The image pickup device according to claim 1 wherein said computer is a notebook computer.

6. The image pickup device according to claim 5 wherein said image pickup module is embedded in an upper edge of a screen of said notebook computer.

7. The image pickup device according to claim 1 wherein said image pickup device is disposed in a web camera, and the web camera is connected to a computer through a universal serial bus.
